(19) United States
(12) Patent Application Publication
(10) Pub. No.: US 2007/0213023 A1
(43) Pub. Date: Sep. 13, 2007

(54) MOBILE DEVICE WITH AM RADIO

(75) Inventor: Takeshi IKEDA, Niigata (JP)

Correspondence Address: PATENTTM.US, P. O. BOX 82788, PORTLAND, OR, 97282-0788, US

(73) Assignee: NIIGATA SEIMITSU CO., LTD., Niigata (JP)

(21) Appl. No.: 11/672,481

(22) Filed: Feb. 7, 2007

(30) Foreign Application Priority Data
Mar. 13, 2006 (JP) 2006-067126

(51) Int. Cl. H04B 1/18; H04B 1/06

(52) U.S. Cl. 455/274; 455/193.1

(57) ABSTRACT

To provide a mobile device with an AM radio which can reduce noise mixed in with a wiring drawn from a bar antenna. A cell-phone 100 includes a bar antenna 22 including a magnetic core and an antenna coil wound around the magnetic core and an AM radio tuner section 20 for performing an AM detection process to a broadcast wave received by the bar antenna 22 and outputting a sound signal after detection. The AM radio tuner section 20 is a one-chip component formed on a semiconductor substrate except for a certain external component, and the one-chip component is placed in proximity to the bar antenna 22.

### BACKGROUND OF THE INVENTION

1. Field of the Invention

The present invention relates to a mobile device such as a cell-phone to which an AM radio function is added.

2. Description of the Related Art

Recently, a cell-phone on which various functions other than its original telephone function are additionally mounted is becoming popular. For instance, a cell-phone provided with an AM radio function is known (refer to Japanese Patent Laid-Open No. 2002-101164 (pp. 3 to 5, FIGS. 1 to 6)). In the case where a mobile device such as the cell-phone is provided with the AM radio function, it is difficult to mount a large loop antenna, a long rod antenna or the like thereon. Therefore, a broadcast wave is received by using a bar antenna wherein a coil is wound around a ferrite.

There was a problem that, if a distance between the bar antenna and a circuit (tuning circuit or the like) of an AM radio becomes long, noise is apt to get mixed in with wiring between them. In the case of the cell-phone in particular, it has a configuration for sending and receiving call signaling and other control signals between it and a color LCD (Liquid Crystal Display) as a noise emitting source and a base station so that the noise thereby generated is apt to get mixed in. There is a method of preventing such noise from getting mixed in by using a shield member. As length of the wiring to be covered by the shield member becomes longer, however, area of the shield member is accordingly expanded so as to lead to cost increase. Therefore, it goes against recent requests for cost reduction and reduction in size and weight, which is not desirable.

The present invention has been made in view of such a point, and an object thereof is to provide a mobile device with an AM radio which can reduce the noise mixed in with the wiring drawn from the bar antenna.

### SUMMARY OF THE INVENTION

To solve the above-mentioned problem, a mobile device with an AM radio of the present invention is the one comprising: a bar antenna including a magnetic core and an antenna coil wound around the magnetic core; and an AM radio tuner section for performing an AM detection process to a broadcast wave received by the bar antenna and outputting a sound signal after detection, and wherein: the AM radio tuner section is a one-chip component formed on a semiconductor substrate except for a certain external component; and the one-chip component is placed in proximity to the bar antenna. The AM radio tuner section is formed as the one-chip component so that a degree of freedom in placement of the one-chip component increases. Therefore, it becomes easier to place the one-chip component in proximity to the bar antenna. It thereby becomes possible to reduce length of wiring between the bar antenna and a circuit of a subsequent stage thereto so as to allow reduction in noise mixed in with the wiring drawn from the bar antenna.

It should also desirably be the one wherein the above-mentioned external component is a capacitor. It is possible, by rendering the capacitor of a large electrostatic capacity requiring large area as the external component, to reduce the area of the one-chip component so as to allow miniaturization of the part and cost reduction in conjunction therewith.

It should also desirably be the one further comprising: an antenna holder for holding the above-mentioned bar antenna, and wherein: the one-chip component is mounted on the antenna holder. It is thereby possible to reduce the length of the wiring between the bar antenna and the AM radio tuner section. It is also possible to make effective use of empty space on a surface of the antenna holder and thereby reduce the area of a printed board provided to the mobile device.

It should also desirably be the one further comprising: an antenna holder for holding the above-mentioned bar antenna; and a wiring member partially fixed to the antenna holder, and wherein: the one-chip component is mounted on a surface of the wiring member. It is thereby possible to reduce the length of the wiring between the bar antenna and the AM radio tuner section. It is also possible to make effective use of the empty space on the surface of the antenna holder and thereby reduce the area of the printed board provided to the mobile device.

It should also desirably be the one wherein the external component is mounted at a position adjacent to the one-chip component on the surface of the wiring member. It is thereby possible to reduce a distance between the one-chip component and the external component mounted on the wiring member so as to reduce the noise mixed in with the wiring connecting them.

It should also desirably be the one wherein the above-mentioned wiring member is a flexible substrate. This facilitates layout of the wiring between the bar antenna and the one-chip component and layout of the wiring between the one-chip component and its subsequent circuit. Use of the flexible substrate also facilitates mounting of the one-chip component.

It should also desirably be the one wherein a shield member is placed around the above-mentioned bar antenna. It should particularly be the one wherein the above-mentioned one-chip component is placed further on the bar antenna side than the shield member. It is thereby possible to shield the noise which comes in the bar antenna side from the circuits other than a display and the AM radio tuner section provided to the mobile device with an AM radio and reduce the noise included in the signal after the AM detection.

It should also desirably be the one further comprising a telephone processing section for processing a telephone call as a mobile telephone. It should also desirably be the one further comprising an audio processing section for reproducing audio data.

It should also desirably be the one wherein the above-mentioned one-chip component is formed on the semiconductor substrate by using a CMOS process or a MOS process. It is thereby possible to miniaturize, and reduce power consumption of, the one-chip component formed on the semiconductor substrate.

### BRIEF DESCRIPTION OF THE DRAWINGS

FIG. 1 is a diagram showing a configuration of a cell-phone of one embodiment;

FIG. 2 is a diagram showing a detailed configuration of an AM radio tuner section;

FIG. 3 is a perspective view showing a usage state of the cell-phone;

FIG. 4 is a perspective view showing a mounting state of a bar antenna and the AM radio tuner section;

FIG. 5 is a plan view showing a modified example of the mounting state of the bar antenna and the AM radio tuner section; and

FIG. 6 is a plan view showing a modified example of the mounting state of the bar antenna and the AM radio tuner section.

### DETAILED DESCRIPTION OF THE PREFERRED EMBODIMENTS

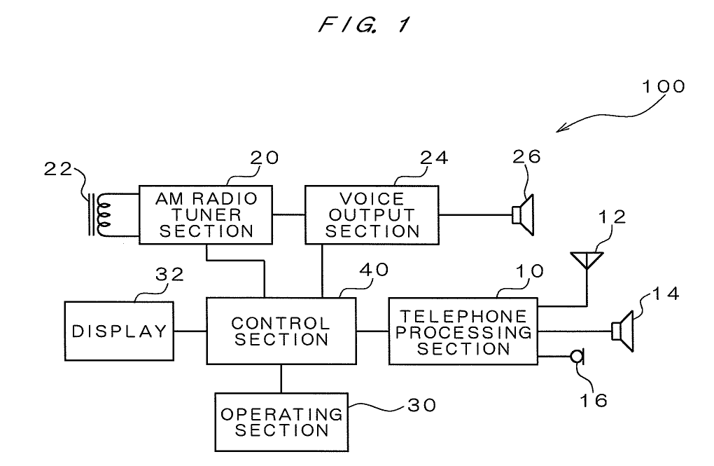

Hereunder, a cell-phone with an AM radio to which the present invention is applied will be described with reference to the drawings. FIG. 1 is a diagram showing a configuration of the cell-phone of one embodiment. As shown in FIG. 1, a cell-phone 100 of this embodiment comprises a telephone processing section 10, an antenna 12, a speaker 14, a microphone 16, an AM radio tuner section 20, a bar antenna 22, a voice output section 24, a speaker 26, an operating section 30, a display 32 and a control section 40. According to this embodiment, the AM radio tuner section 20 is formed as a one-chip component on a semiconductor substrate by using a CMOS process or a MOS process except for a certain external component. It is possible, by using these processes, to miniaturize, and reduce power consumption of, the one-chip component formed on the semiconductor substrate. The external component is used for the capacitor of a large electrostatic capacity requiring large area. It is thereby possible to reduce the area of the one-chip component which forms the AM radio tuner section 20 so as to allow miniaturization of the components and cost reduction in conjunction therewith. According to this embodiment, the telephone processing section 10, voice output section 24 and control section 40 are also formed as one-chip components on the semiconductor substrate by using the CMOS process or the MOS process.

The telephone processing section 10 performs a process necessary to perform a telephone call by using the cell-phone 100 as a mobile telephone between itself and another cell-phone, a fixed-line phone or the like. This process is performed by sending and receiving a radio wave of a predetermined frequency between itself and an adjacent base station (not shown) via the antenna 12. Though omitted in FIG. 1, the cell-phone 100 has functions of sending and receiving mail and accessing the Internet. To implement these functions, it needs to send and receive various kinds of data to and from an outside server, where the sending and receiving of the data is also performed by the telephone processing section 10.

The AM radio tuner section 20 receives an AM radio broadcast by using the bar antenna 22 wound around by an antenna coil 22B which is formed by a copper wire or the like on a magnetic core 22A composed of a magnetic body such as a ferrite so as to perform AM detection and output a sound signal after the detection. The voice output section 24 amplifies the sound signal outputted from the AM radio tuner section 20 and outputs it from the speaker 26. Earphones may also be used instead of the speaker 26 or in conjunction with the speaker 26.

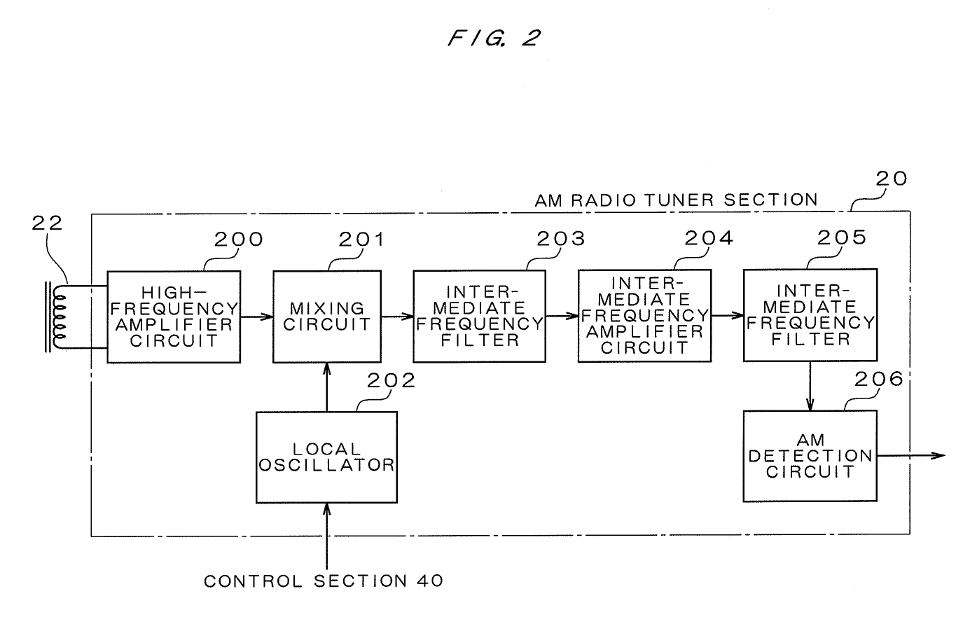

FIG. 2 is a diagram showing a detailed configuration of the AM radio tuner section 20. As shown in FIG. 2, the AM radio tuner section 20 comprises a high-frequency amplifier circuit 200, a mixing circuit 201, a local oscillator 202, intermediate frequency filters 203, 205, intermediate frequency amplifier circuit 204 and an AM detection circuit 206.

After an AM modulation wave signal received by the bar antenna 22 is amplified by the high-frequency amplifier circuit 200, conversion from a high-frequency signal to an intermediate frequency signal is performed by mixing it with a local oscillation signal outputted from the local oscillator 202. If the frequency of the AM modulation wave signal after amplification outputted from the high-frequency amplifier circuit 200 is f1 and the frequency of the local oscillation signal outputted from the local oscillator 202 is f2, the intermediate frequency signal having a frequency of f1±f2 is outputted from the mixing circuit 201. For instance, the intermediate frequency signal of 450 kHz is outputted from the mixing circuit 201.

The intermediate frequency filters 203, 205 are provided to a preceding stage and a subsequent stage of the intermediate frequency amplifier circuit 204, and extract a frequency component included in an occupied frequency band of the modulation wave signal from an inputted intermediate frequency signal. The intermediate frequency amplifier circuit 204 amplifies the intermediate frequency signal. The AM detection circuit 206 performs an AM detection process to the intermediate frequency signal after amplification by the intermediate frequency amplifier circuit 204.

The operating section 30 shown in FIG. 1 includes various keys necessary for receiving the AM radio broadcast in addition to a “*” key and a “#” key as numeric keys necessary when inputting a telephone number. For instance, it is provided with a tuning key for giving an instruction to increase or decrease the frequency as required to select a station when receiving the AM radio broadcast and a volume key for increasing or decreasing an output volume. As for these keys, dedicated keys may be assigned or a part of a numeric keypad may also serve as them.

The display 32 displays various kinds of information required for operation of the cell-phone 100. For instance, it displays the other party's telephone number on making a call, an image of calling indicator and a originator's number on receiving a call, an image indicating internal battery power, an antenna mark indicating intensity of the radio wave transmitted from the base station, a received frequency on receiving the AM radio broadcast and a volume of output sound and the like. As for the display 32, a color liquid crystal display using a TFT (Thin Film Transistor) as an active-matrix active element is used. While the color liquid crystal display is characterized by fast response speed and bright coloration, it becomes a noise source to the AM radio tuner section 20.

FIG. 3 is a perspective view showing a usage state of the cell-phone 100. A housing 50 provided with the operating section 30 on one surface and a housing 52 provided with the display 32 on one surface are openable and closable centering on one end in a longitudinal direction. As shown in FIG. 3, in the state of having the two housings 50 and 52 open, the numeric keys of the operating section 30 provided on the housing 50 are operable while viewing a screen of the display 32 provided on the housing 52.

The control section 40 controls the entire operation of the cell-phone 100. For instance, in the case of receiving the AM radio broadcast, it exerts control to change the received frequency of the AM radio tuner section 20 when the tuning key of the operating section 30 is operated and vary a gain of the voice output section 24 when the volume key is operated. It also performs a control action to display the received frequency and output volume of the AM radio broadcast being received.

The cell-phone 100 of this embodiment has such an overall configuration. Next, a mounting state of the bar antenna 22 and the AM radio tuner section 20 will be described. As shown in FIG. 3, the bar antenna 22 is in the housing 50 on the side having no display 32 placed, and is placed at a position most distant from the display 32 (in proximity to the end of the housing 50) in the state of having the two housings 50 and 52 open. The display 32 is controlled to be in a nondisplay status when in the state of having the two housings 50 and 52 closed.

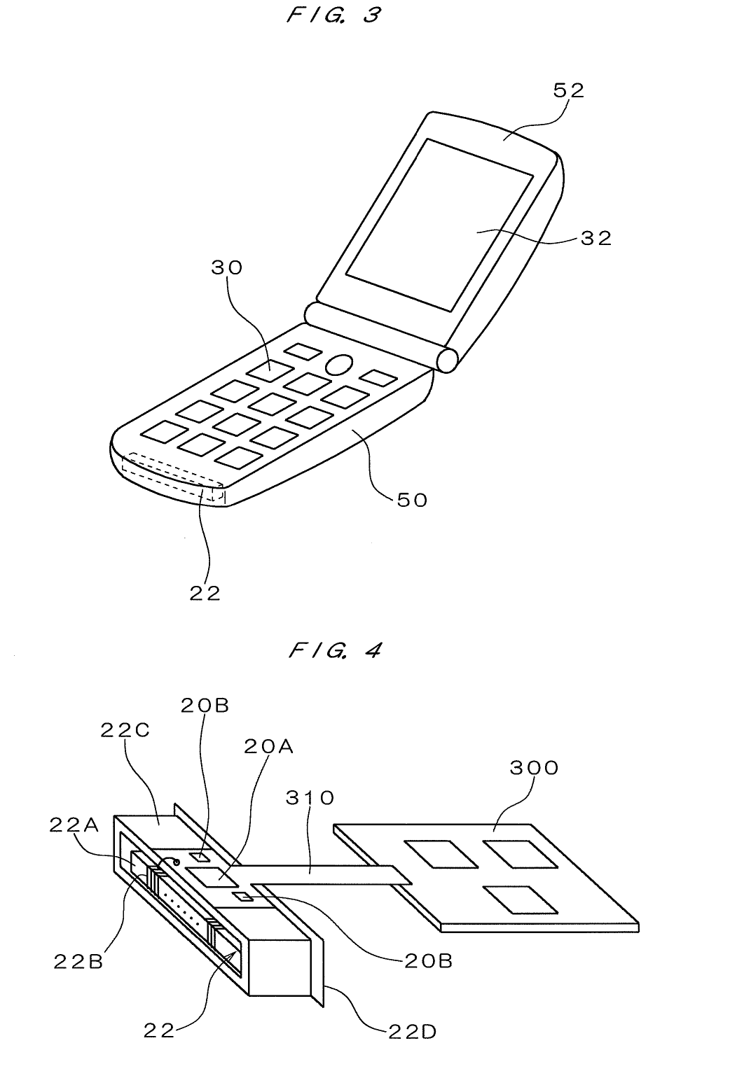

FIG. 4 is a perspective view showing a mounting state of the bar antenna 22 and the AM radio tuner section 20. As shown in FIG. 4, the bar antenna 22 having the magnetic core 22A wound around by the antenna coil 22B is housed and held in a box-shaped antenna holder 22C. The antenna holder 22C has one surface open, and holds the bar antenna 22 by inserting it from the open side. A printed board 300 is placed at a position apart from the antenna holder 22C by a predetermined distance, and a flexible substrate 310 as a wiring member is placed to connect the antenna holder 22C with the printed board 300. A part of the flexible substrate 310 is fixed on the antenna holder 22C.

A one-chip component 20A in which the AM radio tuner section 20 is formed is mounted on the flexible substrate 310. In the example shown in FIG. 4, the one-chip component 20A is mounted on the flexible substrate 310, that is, at a position corresponding to one surface of the antenna holder 22C. An external component 20B which is included in the AM radio tuner section 20 is placed in proximity to the one-chip component 20A on the flexible substrate 310. The printed board 300 has the telephone processing section 10, voice output section 24, control section 40 and the like shown in FIG. 1 mounted thereon. While the example in FIG. 4 shows one printed board 300, the printed board 300 may be replaced by multiple printed boards.

Thus, the cell-phone 100 of this embodiment has the one-chip component 20A forming the AM radio tuner section 20 placed in proximity to the bar antenna 22. As a degree of freedom in placement of the one-chip component 20A is increased by forming the AM radio tuner section 20 as the one-chip component 20A, it becomes easy to place the one-chip component 20A in proximity to the bar antenna 22. It is thereby possible to reduce length of the wiring between the bar antenna 22 and a circuit of a subsequent stage thereto (high-frequency amplifier circuit 200 shown in FIG. 2) and cut down noise mixed in with the wiring drawn from the bar antenna 22. Note that, though the wiring connecting the one-chip component 20A with the printed board 300 becomes long, the noise mixed in with this signal line is not so problematic compared with the noise mixed in with the signals inputted and outputted via the wiring between the bar antenna 22 and the AM radio tuner section 20. The reason why is the sound signal after the detection is outputted from the one-chip component 20A.

As the capacitor of a large electrostatic capacity requiring large area is the external component 20B, it is possible to reduce the area of the one-chip component 20A so as to allow miniaturization of the part and cost reduction in conjunction therewith.

It also comprises the antenna holder 22C for holding the bar antenna 22 and the flexible substrate 310 as the wiring member partially fixed to the antenna holder 22C, and the one-chip component 20A is mounted on the surface of the flexible substrate 310. It is thereby possible to reduce length of the wiring between the bar antenna 22 and the AM radio tuner section 20. It is also possible to make effective use of the empty space on the surface of the antenna holder 22C and thereby reduce the area of the printed board 300 provided to the cell-phone 100.

The external component 20B is mounted at a position adjacent to the one-chip component 20A on the surface of the flexible substrate 310. It is thereby possible to reduce the distance between the one-chip component 20A mounted on the flexible substrate 310 and the external component 20B and cut down noise mixed in with the wiring connecting them.

Use of the flexible substrate 310 as the wiring member facilitates layout of the wiring between the bar antenna 22 and the one-chip component 20A and layout of the wiring between the one-chip component 20A and its subsequent circuit. The use of the flexible substrate 310 also facilitates mounting of the one-chip component 20A.

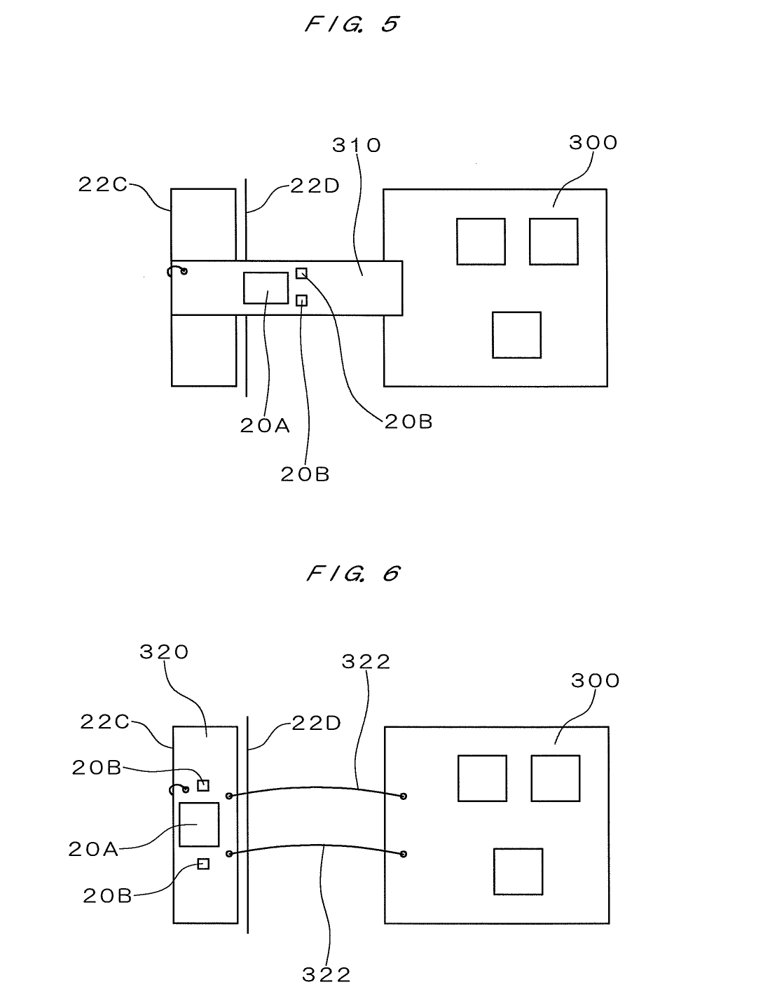

FIGS. 5 and 6 are plan views showing modified examples of the mounting state of the bar antenna 22 and the AM radio tuner section 20. According to the mounting example shown in FIG. 4, the one-chip component 20A is mounted on the flexible substrate 310, and at a position corresponding to one surface of the antenna holder 22C. As shown in FIG. 5, however, the one-chip component 20A and the external component 20B may also be mounted at a position not corresponding to the antenna holder 22C.

As shown in FIG. 6, it is also possible to form one surface of the antenna holder 22C with a printed board 320 and mount the one-chip component 20A and the external component 20B on the printed board 320. In this case, it is also possible to make a connection between the printed board 320 having the one-chip component 20A mounted thereon and the other printed board 300 by means of a simple wiring 322 such as a copper wire other than that of the flexible substrate (though the example in FIG. 6 shows two wirings 322, the necessary number of wirings 322 are used in reality). It is also possible, by mounting the one-chip component 20A and the external component 20B on one surface of the antenna holder 22C, to make effective use of the empty space on the surface of the antenna holder 22C and thereby reduce the area of the printed board 300 provided to the cell-phone 100.

The present invention is not limited to the embodiment but various modified embodiments are possible without departing from the scope of the invention. For instance, according to the above-mentioned embodiment, mixing of the noise was cut down by placing the bar antenna 22 at the position distant from the display 32. However, it is also possible to further cut down the noise mixed in with the bar antenna 22 and the wiring thereof by placing a shield member 22D around the bar antenna 22 as shown in FIGS. 4 to 6. In the case of placing the shield member 22D around the bar antenna 22, it is possible to further cut down the mixing of the noise by placing the one-chip component 20A further on the bar antenna 22 side than the shield member 22D as shown in FIGS. 4 to 6. The form of the shield member 22D is not limited to a flat plate form shown in FIG. 4 and the like but may be a form covering two or more surfaces of the antenna holder 22C. It is a matter of course that the present invention can be provided as to the structure excluding the shield member 22D shown in FIGS. 4 to 6.

The above-mentioned embodiment described the cell-phone 100 comprising the AM radio tuner section 20 as an example of the mobile device with an AM radio. It is also possible to provide the AM radio tuner section 20 and the bar antenna 22 to the mobile device comprising an audio processing section (such as an MP3 player, a CD (Compact Disc) player or an MD (Mini Disc) player) for reproducing audio data. It is also possible to add the audio processing section to the cell-phone 100 of which configuration is shown in FIG. 1. It is also possible to add an FM radio function. The present invention is also applicable to the mobile device provided only with the AM radio (that is, a portable AM radio).

What is claimed is:

1. A mobile device with an AM radio comprising:
a bar antenna including a magnetic core and an antenna coil wound around the magnetic core; and
an AM radio tuner section for performing an AM detection process to a broadcast wave received by the bar antenna and outputting a sound signal after detection, and wherein:
the AM radio tuner section is a one-chip component formed on a semiconductor substrate except for a certain external component; and
the one-chip component is placed in proximity to the bar antenna.

2. The mobile device with an AM radio according to claim 1, wherein the external component is a capacitor.

3. The mobile device with an AM radio according to claim 1, further comprising:
an antenna holder for holding the bar antenna, and wherein:
the one-chip component is mounted on the antenna holder.

4. The mobile device with an AM radio according to claim 1, further comprising:
an antenna holder for holding the bar antenna; and
a wiring member partially fixed to the antenna holder, and wherein:
the one-chip component is mounted on a surface of the wiring member.

5. The mobile device with an AM radio according to claim 4, wherein the external component is mounted at a position adjacent to the one-chip component on the surface of the wiring member.

6. The mobile device with an AM radio according to claim 4, wherein the wiring member is a flexible substrate.

7. The mobile device with an AM radio according to claim 1, wherein a shield member is placed around the bar antenna.

8. The mobile device with an AM radio according to claim 7, wherein the one-chip component is placed further on the bar antenna side than the shield member.

9. The mobile device with an AM radio according to claim 1, further comprising a telephone processing section for processing a telephone call as a mobile telephone.

10. The mobile device with an AM radio according to claim 1, further comprising an audio processing section for reproducing audio data.

11. The mobile device with an AM radio according to claim 1, wherein the one-chip component is formed on the semiconductor substrate by using a CMOS process or a MOS process.
